(19) United States
(12) Patent Application Publication
(10) Pub. No.: US 2026/0264369 A1
(43) Pub. Date: Sep. 10, 2026

(54) FOIL FOR FORMING PACKAGING PARTS AND HOUSING PARTS

(71) Applicant: Profol GmbH, Halfing (DE)

(72) Inventors: Udo Steinhauer, Halfing (DE); Florian Glasedonner, Halfing (DE)

(21) Appl. No.: 19/165,510

(22) PCT Filed: Aug. 16, 2024
(86) PCT No.: PCT/EP2024/073079

§ 371 Date: Sep. 15, 2025

(30) Foreign Application Priority Data
Aug. 16, 2023 (EP) 23191635.4

(51) Int. Cl. B32B 15/085; B32B 7/12; B32B 15/20; B32B 38/00; H01M 50/105; H01M 50/119; H01M 50/121; H01M 50/129; H01M 50/193

(52) U.S. Cl. CPC B32B 15/085; B32B 7/12; B32B 15/20; B32B 38/0008; H01M 50/105; H01M 50/119; H01M 50/121; H01M 50/129; H01M 50/193; B32B 2250/02; B32B 2323/10; B32B 2457/10

(57) ABSTRACT

A foil for forming packaging units or housing units, including a coupling layer that is configured to bond to a metal foil; a core layer having a layer thickness that is at least greater than half the foil thickness, and a sealing layer that is configured to be in permanent contact with an electrolyte.

### TECHNICAL FIELD

The present invention relates to a foil for forming packaging parts and housing parts. The present invention in particular relates to a foil which, together with a diffusion barrier, can form a reliably sealing packaging or housing part for an electrolyte-containing substance or an electrolyte-containing assembly.

### TECHNOLOGICAL BACKGROUND

Electrolyte-containing substances and assemblies are used in a wide range of applications in the electrical, automotive and chemical industries. Electrolyte-containing substances are packaged for further processing or also form corresponding assemblies in the form of electronic components such as batteries. In particular the latter, i.e. batteries, are the subject of intensive further development in the context of electronic consumer goods, electromobility as well as the stationary storage of electrical energy.

Packaging and housings for such electrolyte-containing substances or assemblies must have certain properties, which ensures the safe containment of the substances and assemblies. In particular the function of a diffusion barrier plays a prominent role here, which effectively prevents the leakage and loss of electrolytic components. Metal foils are normally used for this purpose, which generally provide a satisfactory diffusion barrier. Metal foils can also be easily formed into packaging or housing parts since they either retain the shape well that they receive from compression moulding or in any case remain flexible and malleable. Containers for packaging, such as bottles or pouches, or even housings for permanent containment can be reliably provided in this manner.

Even though metal foils generally provide a good diffusion barrier and are easily malleable, they have certain disadvantages in terms of sealing. It is clear that both the packaging and the housings in question must ensure a reliable containment of the substances or assemblies. As a result hereof, the object often arises of reliably joining and sealing metal surfaces at the seams such that containment of the electrolyte is ensured. Metals can generally be welded or soldered well, but this is associated with high heat input and energy consumption.

There is therefore a need for a reliable bonding of diffusion barriers for the production of packaging or housing parts that ensure reliable containment of an electrolyte, an electrolyte-containing substance or a corresponding assembly. It is therefore in particular an object of the present invention to provide a foil for forming packaging or housing units, which ensures a reliable containment of electrolytes and achieves an overall positive balance of advantages in terms of processing, weight and energy consumption.

### SUMMARY OF THE INVENTION

The aforementioned and further advantages are provided by the foil according to patent claim 1. Further advantageous embodiments of the present invention are specified in the dependent patent claims.

According to one aspect of the present invention, a foil is provided for forming packaging units or housing units, comprising a coupling layer that is configured to bond to a metal foil; a core layer having a layer thickness that is at least greater than half the foil thickness, and a sealing layer that is configured to be in permanent contact with an electrolyte.

### BRIEF DESCRIPTION OF THE DRAWINGS

Embodiments of the present inventions will now be described in more detail with reference to the following figures. The corresponding description merely serves to provide a better understanding of the teaching according to the invention and the advantages associated therewith, but should not be understood as limiting at any point. The figures show the following:

FIG. 1 schematically shows the basic structure of a foil according to an embodiment of the present invention;

FIG. 2 schematically shows the basic structure of a packaging or housing intermediate product with a foil according to an embodiment of the present invention;

FIGS. 3A to 3E schematically show possible shapes of packaging or housing parts made from a foil according to an embodiment of the present invention; and

FIGS. 4A & 4B schematically show possible applications of a foil according to an embodiment of the present invention.

### DETAILED DESCRIPTION

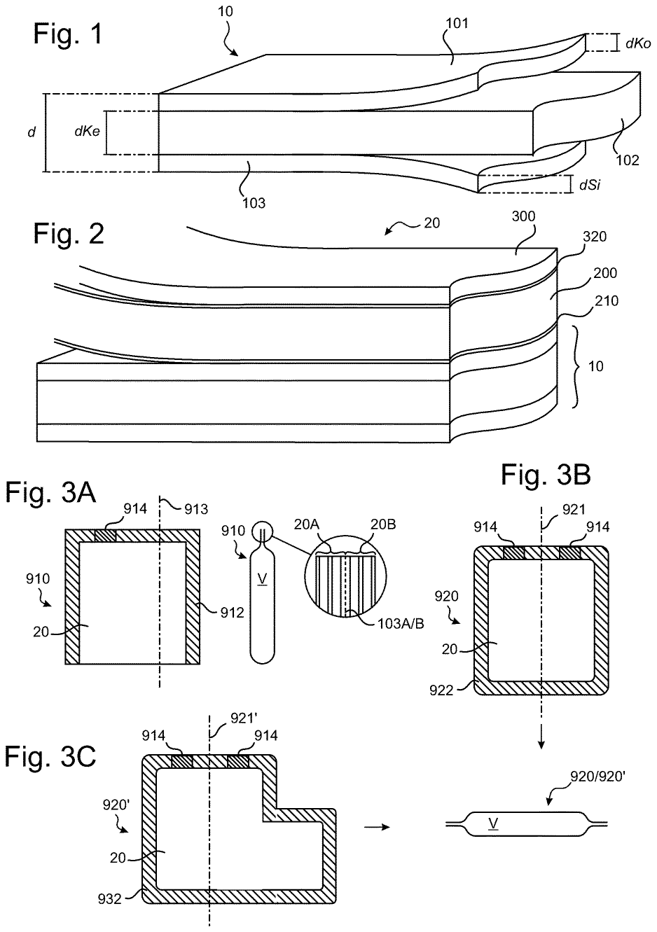

FIG. 1 schematically shows the basic structure of a foil according to an embodiment of the present invention. A foil 10 is used for forming packaging or housing units, in particular for the containment of an electrolyte, an electrolyte-containing substance or an electrolyte-containing assembly. These uses as well as the shapes of the corresponding packaging and housings are described in more detail in connection with further embodiments. The foil 10 can preferably be the product of coextrusion, in which the materials of the individual layers are brought together in a molten state in order to solidify at the extrusion die or outlet as foil 10. In this manner, the respective layer properties and layer strengths (thicknesses) can be provided by corresponding intermediate products and their quantity rates. The foil 10 can generally be provided as a cast foil, in particular a cast polypropylene (CPP) foil, if polypropylene or other polyolefin-based plastics are used.

The foil 10 comprises a coupling layer 101 that is configured to bond to a metal foil. An adhesion promoter may optionally be used for bonding the coupling layer 101, such that the properties of the coupling layer 101 are either tailored to direct bonding to a metal foil or to bonding to the metal foil via an adhesion promoter. Such an adhesion promoter can be provided by adding an adhesion promoter additive to the coupling layer, for example during extrusion. An adhesion promoter can furthermore also be provided via a (separate) adhesive system or adhesive (glue). In the latter case, the adhesion promoter, for example in the form of an adhesive system, can at least indirectly have an influence on the properties of the coupling layer via the metal foil. This coupling layer 101 may consist of a polyolefin-based plastic such as polypropylene, or at least comprise this. The coupling layer 101 may be corona pre-treated in order to bond well to a metal foil or metal layer in a subsequent manufacturing step, possibly by means of an adhesion promoter (for example an adhesive system on aluminium). (for example with a).

The coupling layer 101 may preferably have undergone corona pre-treatment. With such a corona pre-treatment, the surface tension of the coupling layer can be increased as compared to a layer without such a pre-treatment. For example, the surface tension can be increased to values of >30 mN/m (dyne), preferably >38 mN/m (dyne). The surface tension can be measured using a dyne test ink pen or by contact angle measurement, and is thus a feature of the corresponding embodiments. Corona pre-treatment can advantageously improve the bonding of the coupling layer to the metal foil, in particular when using the optional adhesion promoters or adhesives. The coupling layer 101 can otherwise bond directly to the metal foil by thermal lamination. The coupling layer 101 may have a layer thickness in a range of 4 μm to 20 μm, or preferably in a range of 5% to 20% of the thickness of the foil 10.

The foil 10 furthermore comprises a core layer 102, which contributes in particular to achieving the desired elasticity, toughness and/or performance strength of the overall structure of the foil 10 and/or the packaging or housing part. For this reason, among others, the core layer 102 has a layer thickness dKE which is at least greater than half the foil thickness d, preferably even substantially equal to or greater than 70% of the foil thickness d. The core layer 102 may have a layer thickness in a range of 20 μm to 200 μm.

The foil 10 furthermore comprises a sealing layer 103 that is configured to be in permanent contact with an electrolyte. The sealing layer can furthermore seal well with another sealing layer, for example also with an area of the same sealing layer of the same foil at another point, to provide a reliable seal. Sealing can be carried out by heat-induced thermowelding or ultrasonic welding. The sealing layer is characterised by the formation of a high-strength seal seam. The sealing layer is furthermore characterised in that it has a low sealing point, i.e. it already seals at relatively low temperatures, preferably at temperatures from 100° C. Special PP polymer types can be used for this purpose, which have been modified during production such that a sealing point below that of a normal, unmodified PP is achieved and a highly durable seal seam can thus be provided. The sealing layer can furthermore be characterised in that sealing functions without any significant change in the sealing ability even if the sealing surface is wetted with electrolytes.

Examples of such electrolytes include lithium phosphates, such as lithium hexafluorophosphate, which are dissolved in ethylene carbonate, dimethyl carbonate and/or diethyl carbonate. An advantageous property for resistance against permanent contact with an electrolyte may be chemical resistance and the migration behaviour of the electrolyte solution through the foil 101. Otherwise, a migration of electrolyte solution through the foil can attack or degrade the adhesion of the metal foil. This can lead to delamination, which, however, is effectively prevented by the embodiments of the present invention. The desired resistance can be achieved, for example, by using cast polypropylene, cast PP. The sealing layer 103 may have a layer thickness in a range of 2 μm to 20 μm, or preferably in a range of 5% to 20% of the thickness of the foil 10.

Depending on the application, the layer thicknesses mentioned above result in a total layer thickness d of the foil 10. For example, for use in mobile devices, the total thickness of the foil may be 30 to 50 μm or, for example, 40 μm. For high-voltage batteries in the automotive industry, the foil thickness may be in a range of 70 μm to 90 μm, preferably approximately 80 μm. If aluminium is selected as the metal, the foil 10 can then be referred to as aluminium laminated foil, or ALF for short, which is preferably provided as a three-layer coextruded foil made of CPP for lamination.

FIG. 2 schematically shows the basic structure of a packaging or housing intermediate product with a foil according to an embodiment of the present invention. A semi-finished product 20 is in particular shown, which is also film-like or plate-like and which comprises a foil 10 for forming packaging or housing units such as described elsewhere in the present disclosure. The semi-finished product furthermore comprises a metal layer 200 in the form of a metal foil, a metal plate or a sheet metal. Advantageously, the metal layer is an aluminium foil having a material thickness in the range of 10 to 100 μm or 30 to 50 μm.

The semi-finished product 20 is bonded to the foil 10 with an adhesive 210, preferably a laminate adhesive, a two-component adhesive or a polyurethane, PU, adhesive. In an advantageous embodiment, the foil 10 is first of all corona pre-treated, which improves the bonding to the metal layer 200 via the adhesive 210. An outer protective layer 300 is furthermore disposed on the metal layer 200, which consists, for example, of polyamide (PA) and/or polyethylene terephthalate (PET) or at least contains it. The protective layer 300 may be bonded to the metal layer 200 with a further adhesive 320. The protective layer 300 may have a material thickness in the range of 10 to 30 μm or 15 to 20 μm. A typical layer thickness for the overall composite 20 may then be approximately 140 μm, for example. If aluminium is used as the metal layer, this layer can then be laminated on one side with an aforementioned coextruded foil and a polyamide foil in an at least 3-layer composite by means of adhesive systems (for example co-extruded PP-aluminium-PA-PET).

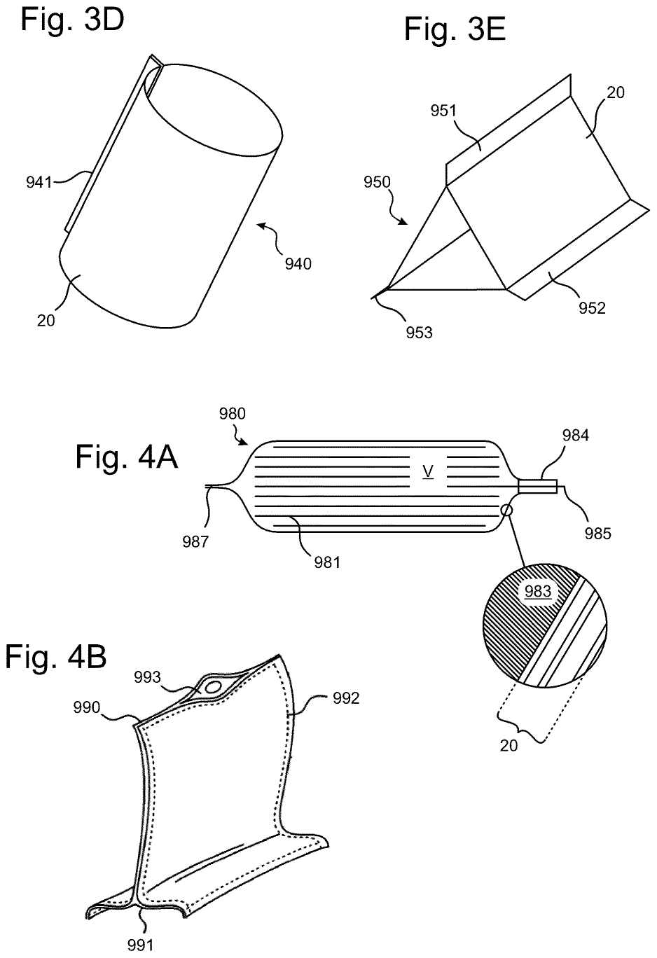

FIGS. 3A to 3E schematically show possible shapes of packaging or housing parts made of a foil according to an embodiment of the present invention. FIG. 3A shows a simple pouch shape 910, for which a semi-finished product 20 has been folded over into a rectangular shape along a fold 911 and welded on the remaining sides in areas 912. The sealing layers 103 of the semi-finished product 20 advantageously meet at these points and provide a reliable containment of the volume V by welding (here, in the inset, the sealing layers 103 of the semi-finished products 20A and 20B fuse in an area 103A/B). One or more access points 914 can be incorporated into the welded areas 912, which provide access to the inner volume V and thus, for example, provide an electrical contact in the case of a battery housing or a closure in the case of packaging. A sectional view of the pouch shape 910 with the volume V along the axis 913 is shown in the right-hand area.

Further pouch shapes are shown in FIGS. 3B and 3C, which can essentially have a rectangular basic shape, as in the case of pouch 920 (FIG. 3B), or any desired shape, as in the case of pouch 920′ (FIG. 3C). By means of a foil according to the invention and a corresponding semi-finished product, pouches of almost any shape can be obtained by welding the corresponding edge area 922, 932, wherein the respective sealing layers can again lie on top of one another and be welded. One or more access points 914 can also be provided in these shapes, the respective position of which can be advantageously placed at the most favourable location for the specific use since the pouch structure with the foil or semi-finished product according to the invention provides great flexibility here. The cross-sectional view 920/920′ with the volume V therein schematically results in both cases.

FIG. 3D shows a cylindrical shape 940, which results from simply rolling a semi-finished product 20. Pouches with a cylindrical or cup shape can also be produced in this manner via at least one welded area 941. FIG. 3E shows a pouch 950 with a prismatic shape, which results from a combination of one or more folds and one or more welded areas 951 (and possibly 952, 953).

FIG. 4A schematically shows a possible use of a foil according to an embodiment of the present invention. In this use, a battery 980 is provided, which is, for example, a rechargeable battery, a lithium-ion battery, a lithium-polymer battery, a solid-state battery or the like. An electrolyte-containing assembly comprises an electrode structure 981 and an electrolyte 983, wherein the inner sealing layer 103 of the semi-finished product 20 is in contact with the electrolyte 983 (see inset). In pouch-type batteries, so-called “pouch cells”, a plurality of rectangular layers of positive and negative electrodes and conductor foils are normally stacked in a sandwich configuration with corresponding layers of separators. The electrodes are usually discharged on one side. The outer sheathing and sealing are provided by deep-drawn welded plastic-aluminium-plastic multilayer foils.

The housing comprises a pouch made of a foil 10 or semi-finished product 20 according to the invention, which is obtained by welding at least one area 987. This allows maximum flexibility in terms of the shape of the battery housing, and thus a corresponding battery, for example a so-called pocket or pouch cell, can be provided in an advantageous manner. An access point in the form of a contact 984 may be provided in one of the welded areas 987, which leads a battery contact 985 out of the inner volume V and out of the assembly in an electrically insulated manner.

For such uses, the semi-finished product, for example a pouch battery film structure “CPP film-aluminium foil-PA foil”, can be brought into a (usually) rectangular cavity shape by means of stamping or compression moulding, with two of these shapes being sealed together by means of thermal or ultrasonic welding to form the housing for the battery assembly (coil and electrolyte). After sealing (welding), the sealing layer remains permanently and reliably on the aluminium foil laminated by the adhesive system. Even if damage occurs or at the end of the service life, a residual foil should remain on the metal layer, for example the aluminium foil, in the event of delamination or tearing/separation of the seal seam. At this point it should be mentioned that “permanent” in the context of the present disclosure generally means at least the duration of a planned service life or period of use of the corresponding product (packaging, housing, battery, etc.). Even in the worst case scenario of delamination, the embodiments of the present invention still offer the significant advantage that a residual layer, for example of PP, remains on the metal foil as a thin protective layer.

This is achieved in particular by the composite structure of the semi-finished product in that, under maximum load, the composite within the foil breaks up, i.e. the coupling layer detaches from the core layer and/or the core layer detaches from the (welded) sealing layer and the metal foil remains protected from contact with the electrolyte by the residual foil. In any case, a residual layer of the foil remains on the aluminium, for example, and the electrolyte solution can advantageously be prevented from coming into contact with the aluminium foil. Delamination can also be demonstrated by the so-called white break indicator, in which, for example, a PP layer remains on the aluminium foil.

FIG. 4B schematically shows a possible use of a foil according to an embodiment of the present invention. In this use, a packaging 990 is provided in the exemplary form of a stand-up pouch. For this purpose, a semi-finished product is produced by means of a combination of one or more folds 991 and one or more welded areas 992. An access point in the form of a closure 993 may be provided in one of the welded areas, which enables the packaging to be filled and/or emptied. By using a foil 10 or semi-finished product 20 according to the invention, a reliable product packaging can be obtained, which also reliably contains electrolyte-containing substances.

1. A foil for forming packaging units or housing units, the foil comprising:
a coupling layer that is configured to bond to a metal foil;
a core layer having a layer thickness that is at least greater than half the foil thickness; and
a sealing layer that is configured to be in permanent contact with an electrolyte.

2. The foil according to claim 1, wherein the coupling layer is configured to bond to a metal foil in that is has a corona pretreatment that promotes bonding to the metal foil via an adhesion promoter.

3. The foil according to claim 2, wherein the adhesion promoter comprises an adhesive or adhesive system.

4. The foil according to claim 1, wherein the coupling layer is configured to bond to a metal foil in that it comprises an adhesion promoter additive that promotes bonding to the metal foil.

5. The foil according to claim 4, wherein the coupling layer bonds directly to the metal foil by means of the adhesion promoter additive.

6. The foil according to claim 1, wherein the sealing layer forms a weld or seal connection even if previously wetted by an electrolyte.

7. The foil according to claim 1, wherein the coupling layer, the core layer and the sealing layer are present in a co-extruded structure.

8. The foil according to claim 1, wherein the coupling layer, the core layer and/or the sealing layer comprise a polyolefin-based plastic.

9. The foil according to claim 8, wherein the polyolefin-based plastic is a cast polypropylene, cast PP.

10. A semi-finished product for forming packaging units or housing units, comprising a foil according to claim 1 and a metal foil bonded to the coupling layer.

11. The semi-finished product according to claim 10, wherein the metal foil is an aluminum foil.
